(19) United States
(12) Patent Application Publication
(10) Pub. No.: US 2024/0160815 A1
(43) Pub. Date: May 16, 2024

(54) METHODS, SYSTEMS AND STORAGE MEDIA FOR PREDICTING OIL SPILL AREAS ON SEA SURFACES

(71) Applicant: CHANGZHOU UNIVERSITY, Changzhou (CN)

(72) Inventors: Hong JI, Changzhou (CN); Ting WANG, Changzhou (CN); Ke YANG, Changzhou (CN); Yaxin WANG, Changzhou (CN); Jie GUO, Changzhou (CN)

(73) Assignee: CHANGZHOU UNIVERSITY, Changzhou (CN)

(21) Appl. No.: 18/510,587

(22) Filed: Nov. 15, 2023

Related U.S. Application Data
(63) Continuation of application No. PCT/CN2023/121388, filed on Sep. 26, 2023.

(30) Foreign Application Priority Data
Nov. 11, 2022 (CN) 202211410700.9

(51) Int. Cl. E21B 43/01

(52) U.S. Cl. CPC E21B 43/0122

(57) ABSTRACT

Embodiments of the present disclosure provide a method, system, and storage medium for predicting an area of oil spill on sea surface, the method for predicting the area of oil spill on sea surface includes: S1, obtaining a training dataset; S2, constructing an oil spill numerical model, and determining a predictive model by performing a predetermined processing on an initial predictive model based on simulation result data and the training dataset; S3, initializing the predictive model, determining a count of nodes of an input layer, an output layer, and a hidden layer; and S4, obtaining input data and inputting the input data into the predictive model in S2 to obtain an oil spill area on sea surface to be measured. The method, when used, has a small error and high accuracy, can save a lot of material and financial resources, and can be more widely used in real life.

### CROSS-REFERENCE

This application is a Continuation of International Application No. PCT/CN2023/121388, filed on Sep. 26, 2023, which claims priority to Chinese Patent Application No. 202211410700.9, filed on Nov. 11, 2022, the entire contents of each of which are hereby incorporated by reference.

### TECHNICAL FIELD

The present disclosure relates to the field of marine environmental sciences, and in particular, to a method, system and storage medium for predicting an oil spill area on sea surface.

### BACKGROUND

With the increasing consumption of industrial oil, people are no longer satisfied with the depletion of onshore oil resources and have turned their attention to the ocean. During the extraction and transportation of marine petroleum products, underwater oil spill accidents caused by corrosion of underwater pipelines and other issues occur frequently. The occurrence of oil and gas leakage accidents not only affects oil security, resulting in casualties and economic losses, but also poses a threat to the survival of marine species and the environment. If spilled oil accumulates on the sea surface, it not only affects nearby vessels but also poses a safety hazard to oil platforms. When an oil film on the water surface encounters an open flame, it can potentially lead to secondary disasters such as fire or explosion.

In the previous studies on the oil spill area on the sea surface, most of them focused on single factors and did not consider the complexity and comprehensiveness of factors affecting submarine oil pipeline leaks. Moreover, in the process of searching for data on the influencing factors of submarine oil pipeline leaks, there is a significant cost but limited accuracy in identifying the factors affecting the area of oil spills on the sea surface, resulting in a lack of comprehensive research on the influencing factors. Therefore, it is necessary to conduct numerical simulation studies on the diffusion pattern of oil spills caused by submarine oil pipeline leaks. The results of the numerical simulation study can provide insights into the transportation process and size of the oil film area on the sea surface resulting from the leakage of submarine oil pipelines.

Therefore, it is hoped to propose a method, system, and storage medium for predicting an oil spill area on sea surface that can process simulated data and build a predictive model for the oil spill area on the sea surface. This will provide data support for oil spill accidents at sea and enable the early determination of the trajectory of the oil spill and the size of the oil film on the sea surface. People can respond promptly by cleaning up the oil effectively in accordance with an emergency plan, controlling the spread of marine pollution areas, and minimizing the dangers caused by underwater oil leakage.

### SUMMARY

The technical problem to be solved by the present disclosure is: in order to solve the problem that the existing process of searching for data of influencing factors affecting a leakage of a submarine oil pipeline, which is labor-intensive, material-intensive, and financial-intensive, and has not yet been able to accurately find out the influencing factors affecting the oil spill area on sea surface. There is also an issue with the lack of comprehensiveness in the research on these factors. This present disclosure provides a method for predicting an oil spill area on sea surface.

One or more embodiments of the present disclosure provide a method for predicting the oil spill area on sea surface. The method is implemented by a processor and includes: S1, obtaining a training dataset, including influencing factors affecting a leakage of a submarine oil pipeline; S2, constructing an oil spill numerical model, and determining a predictive model by performing a predetermined processing on an initial predictive model based on simulation result data and the training dataset, the predictive model being a machine learning model; S3, initializing the predictive model, determining a count of nodes of an input layer, an output layer, and a hidden layer, wherein an input of the input layer is the training dataset, the oil spill area on sea surface is an output of the output layer, and the count of nodes of the hidden layer is related to at least one of the count of nodes of the input layer and the count of nodes of the output layer; and S4, obtaining input data and inputting the input data into the predictive model in S2 to obtain an oil spill area on sea surface to be measured.

One of the embodiments of the present disclosure provides a system for predicting an oil spill area on sea surface, including an obtaining module, a first determination module, a second determination module, and a prediction module. The obtaining module is configured to obtain a training dataset, including influencing factors affecting a leakage of a submarine oil pipeline; the first determination module is configured to construct an oil spill numerical model, and determine a predictive model by performing a predetermined processing on an initial predictive model based on simulation result data and the training dataset, the predictive model being a machine learning model; the second determination module is configured to initialize the predictive model, and determine a count of nodes of an input layer, an output layer, and a hidden layer, wherein an input of the input layer is the training dataset, the oil spill area on sea surface is an output of the output layer, and the count of nodes of the hidden layer is related to at least one of the count of nodes of the input layer and the count of nodes of the output layer; and the prediction module is configured to obtain input data and inputting the input data into the predictive model to obtain an oil spill area on sea surface to be measured.

One or more embodiments of the present disclosure provide a non-transitory computer-readable storage medium storing a computer instruction, when executed by a processor, a computer instruction implements the method for predicting an oil spill area on sea surface.

The beneficial effect of the present disclosure is that the described method for predicting the oil spill area on sea surface has a small error and a high degree of accuracy, and it can save a lot of material and financial resources and can be more widely used in real life. The predictive model is determined by constructing an oil spill numerical model, and pre-setting the initial predictive model based on the simulation result data and the training dataset. At the same time, the actual measured area of oil film on the surface of the water after the accident and the simulation value error are kept within the controllable interval, which can better predict the area of the oil film on the surface of the sea after the emergence of the oil spill accident, and provide data support for subsequent emergency response to the sudden oil spill accident. It can provide data support for the subsequent emergency response to the sudden oil spill accident.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is an exemplary block diagram of a system for predicting an oil spill area on sea surface according to some embodiments of the present disclosure;

FIG. 2 is an exemplary flowchart of a method for predicting an oil spill area on sea surface according to some embodiments of the present disclosure;

FIG. 3 is an exemplary schematic diagram of determining a predictive model according to some embodiments of the present disclosure;

FIG. 4 is an exemplary flowchart of determining an oil film area on sea surface according to some embodiments of the present disclosure;

FIG. 5 is an exemplary schematic diagram of a process for predicting an oil spill area on sea surface according to some embodiments of the present disclosure;

FIG. 6 is a topology diagram of a predictive model for predicting an area of diffusion of the oil film on sea surface according to some embodiments of the present disclosure;

FIG. 7 is a performance diagram of mean squared error (MSE) metrics for a training process according to some embodiments of the present disclosure;

FIG. 8A is an exemplary schematic diagram of a first kind of fit curves of the predictive model according to some embodiments of the present disclosure;

FIG. 8B is an exemplary schematic diagram of a second kind of fit curves of the predictive model according to some embodiments of the present disclosure;

FIG. 8C is an exemplary schematic diagram of a third kind of fit curves of the predictive model according to some embodiments of the present disclosure;

FIG. 8D is an exemplary schematic diagram of a fourth kind of fit curves of the predictive model according to some embodiments of the present disclosure; and

FIG. 9 is a test error diagram of an oil spill area according to some embodiments of the present disclosure.

### DETAILED DESCRIPTION

The present disclosure is described in further detail below in connection with embodiments:

The present disclosure is not limited to the following specific embodiments, and those skilled in the art, based on the contents disclosed in the present disclosure, may adopt a variety of other specific embodiments to implement the present disclosure, or where the design structure and ideas of the present disclosure are adopted, making simple changes or alterations, all fall into the scope of protection of the present disclosure. It should be noted that the embodiments and the features in the embodiments in the present disclosure may be combined with each other without conflict.

In the description of the present disclosure, it is to be understood that the terms “center,” “longitudinal,” “lateral,” “upper,” “lower,” “front,” “rear,” “left,” “right,” “vertical,” “horizontal,” “top,” “bottom,” “inner,” “outer,”, etc., indicate an orientation or positional relationship shown in the accompanying drawings. The orientations or positional relationships are only intended to facilitate the description of the present disclosure and to simplify the description and are not intended to indicate or imply that the device or element referred to must have a particular orientation, be constructed and operated in a particular orientation, and therefore are not to be construed as a limitation of the present disclosure. Additionally, the terms “first”, “second”, etc., are used for descriptive purposes only and are not to be construed as indicating or implying relative importance or implicitly specifying the count of technical features indicated. Thereby, the feature defined with “first”, “second”, etc., may explicitly or implicitly include one or more such features. In the description of the present disclosure, “a plurality of” is meant to be two or more unless otherwise indicated.

In the description of the present disclosure, it should be noted that, unless otherwise expressly provided and limited, the terms “mounted”, “attached to”, “connected with”, etc., are to be understood in a broad sense, e.g., as a fixed connection, a removable connection, an integrated connection, a mechanical connection, an electrical connection, a direct connection, an indirect connection through an intermediary medium, or a connection within two elements. To those skilled in the art, the specific meaning of the above terms in the present disclosure may be understood in context.

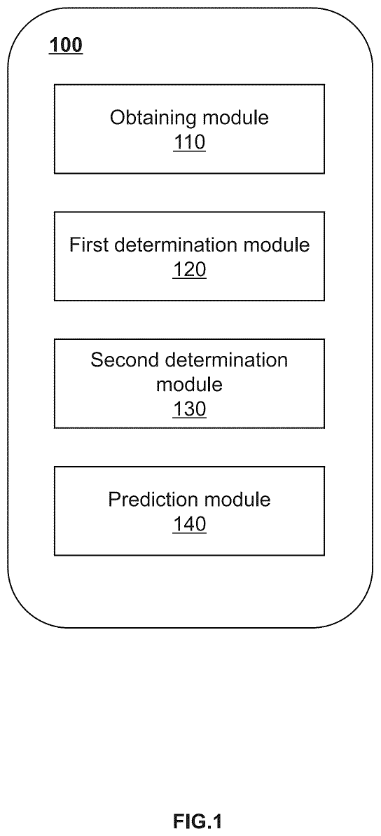

FIG. 1 is an exemplary block diagram of a system for predicting an oil spill area on sea surface according to some embodiments of the present disclosure.

As shown in FIG. 1, a system 100 for predicting an oil spill area on sea surface may include an obtaining module 110, a first determination module 120, a second determination module 130, and a prediction module 140.

In some embodiments, the obtaining module 110 may be configured to obtain a training dataset. The training dataset may include influencing factors affecting a leakage of a submarine oil pipeline, etc.

In some embodiments, the first determination module 120 may be configured to construct an oil spill numerical model, and determine a predictive model by performing a predetermined processing on an initial predictive model based on simulation result data and the training dataset. Wherein, the predictive model may be a machine learning model.

In some embodiments, the second determination module 130 is configured to initialize the predictive model, and determine a count of nodes of an input layer, an output layer, and a hidden layer. Wherein an input of the input layer is the training dataset, and an output of the output layer is the oil spill area on sea surface. The count of nodes of the hidden layer is related to at least one of the count of nodes of the input layer and the count of nodes of the output layer.

In some embodiments, the prediction module 140 is configured to obtain input data and input the input data into the predictive model to obtain an oil spill area on sea surface to be measured.

In some embodiments, the predetermined processing includes training, testing, and verification. The first determination module 120 is further configured to screen data satisfying a preset condition to train the initial predictive model among the simulation result data; in response to a training result satisfying a training completion condition, determine that the training is completed; test the predictive model based on first remaining data to obtain accuracy of the predictive model; verify the predictive model based on second remaining data; and obtain that R correlation of the training, testing, and verification all exceeds a correlation threshold.

In some embodiments, the training dataset may include historical leakage data. The first determination module 120 is further configured to determine the predictive model by performing the predetermined processing on the initial predictive model based on the simulation result data, the training dataset, and an actual diffusion result. A ratio of a first sample count of the simulation result data to a second sample count of the actual diffusion result is determined based on a test feature.

In some embodiments, the historical leakage data may be collected by means of a detection device and/or a movable standby detection device.

In some embodiments, the historical leakage data may further include calibrated data. The first determination module 120 is further configured to obtain first detection data of the detection device; obtain second detection data of the standby detection device; and obtain the calibrated data by performing a comprehensive processing on the first detection data and the second detection data.

In some embodiments, the predictive model may include a feature extraction layer and a first prediction layer. The prediction module 140 is further configured to determine a feature vector through the feature extraction layer based on a leakage aperture size, a leakage velocity, and a water flow velocity; and determine an oil film area on sea surface at at least one future time point through the first prediction layer based on the feature vector and a leakage time series. Wherein, the at least one future time point corresponds to the leakage time series.

In some embodiments, the predictive model further includes a second prediction layer. The prediction module 140 is further configured to determine an oil film area distribution at the at least one future time point through the second prediction layer based on the feature vector, the leakage time series, a weather condition in a future time period and a location of a leakage pipeline.

In some embodiments, the predictive model further includes a third prediction layer. The prediction module 140 is further configured to determine an appearance time of an oil film through the third prediction layer based on a leakage aperture size, a leakage velocity, a water flow velocity and a weather condition in a future time period.

In some embodiments, the system 100 for predicting the oil spill area on sea surface may include a processor, and the processor may include the above-described obtaining module 110, the first determination module 120, the second determination module 130, and the prediction module 140. The processor may process information and/or data related to the system 100 for predicting the oil spill area on sea surface to perform one or more of the functions described in the present disclosure. In some embodiments, the system 100 for predicting the oil spill area on sea surface may also include a user terminal, a network, and/or other components that connect the system to external resources. The user terminal refers to one or more terminal devices or software used by a user. The user refers to, for example, a manager or operator of the system 100 for predicting the oil spill area on sea surface. For example, the processor may be communicatively connected via a network to a filming device, a water flow testing device, a sensing device, etc., to obtain relevant information and/or data.

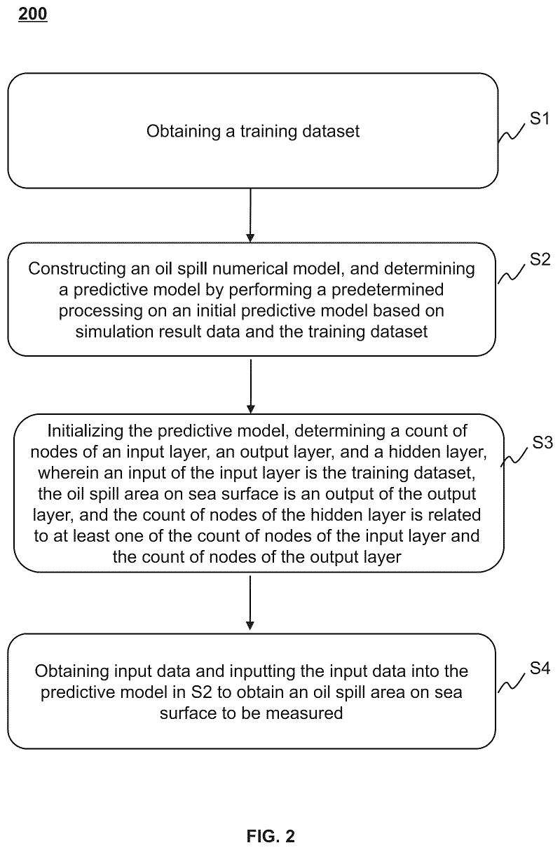

For more on the above-described system 100 for predicting the oil spill area on sea surface, reference may be made to the relevant descriptions of FIGS. 2-9.

It is to be noted that the above description of the system 100 for predicting the oil spill area on sea surface and its modules is provided only for descriptive convenience, and it does not limit the present disclosure to the scope of the cited embodiments. It is to be understood that for those skilled in the art, after understanding the principle of the system, it may be possible to arbitrarily combine individual modules or form a sub-system to connect with other modules without departing from this principle. In some embodiments, the obtaining module 110, the first determination module 120, the second determination module 130, and the prediction module 140 disclosed in FIG. 1 may be different modules in a single system, or a single module may implement the functions of two or more of the modules described above. For example, the individual modules may share a common storage module, and the individual modules may each have a respective storage module. Deformations such as these are within the scope of protection of the present disclosure.

FIG. 2 is an exemplary flowchart of a method for predicting an oil spill area on sea surface according to some embodiments of the present disclosure. As shown in FIG. 2, a process 200 includes the following steps. In some embodiments, the process 200 may be executed by a processor.

Step S1, obtaining a training dataset.

The training dataset is a collection of data that may be used for model training. In some embodiments, the training dataset includes influencing factors affecting a leakage of a submarine oil pipeline. The training dataset may include a plurality of influencing factors, e.g., the training dataset may include at least one of a leakage time, a leakage aperture size, a leakage velocity, or a water flow velocity.

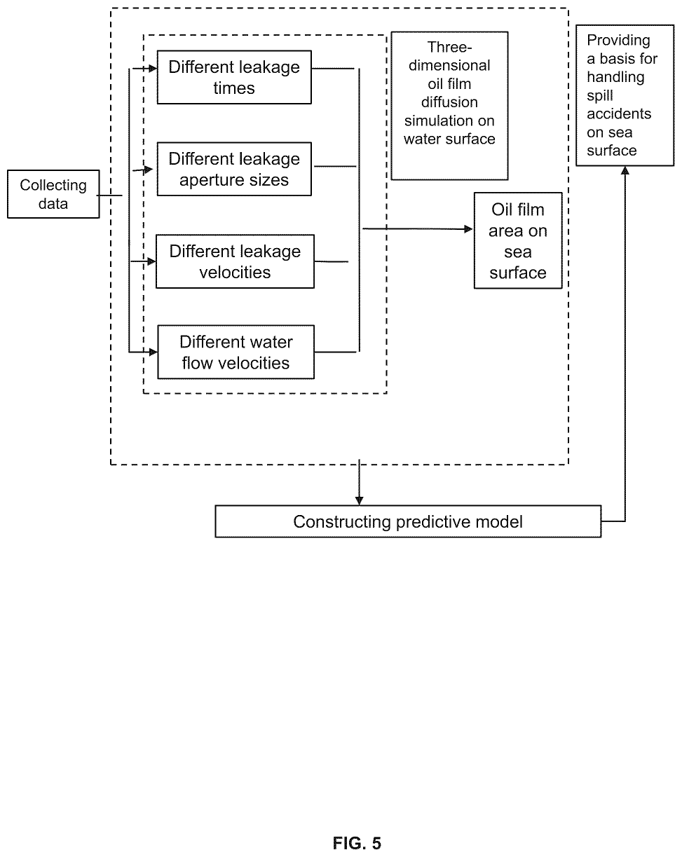

In some embodiments, a source of data in the training dataset is not limited. The data may be computational data or data from one of any input model. For example, the data in the training dataset includes simulated data from a computer simulation source, which may be experimental data derived from a laboratory, measured engineering data, etc. More about the training dataset may be found in the related description of FIG. 5.

The leakage aperture size is a size of an aperture at a leakage of the submarine oil pipeline. The leakage velocity is a velocity at which oil leaks from the submarine oil pipeline. The water flow velocity is a velocity of flow of seawater near a leaking pipeline. The leakage time is a length of time of the leakage.

In some embodiments, the processor may obtain the training dataset in a variety of ways. For example, the processor may obtain actual measured engineering data as the training dataset. As another example, the processor may obtain the training dataset through pre-experimentation. The processor may also obtain the training dataset in other ways, and there is no restriction on the approach of data acquisition here.

Step S2, constructing an oil spill numerical model, and determining a predictive model by performing a predetermined processing on an initial predictive model based on simulation result data and the training dataset.

The oil spill numerical model is a model to simulate and test the oil spill area on sea surface. A description of the oil spill area on sea surface may be found below.

In some embodiments, the processor may construct the oil spill numerical model based on a Computational Fluid Dynamics (CFD) software platform.

The simulation result data refers to a simulated value of the oil spill area on sea surface obtained by the oil spill numerical model.

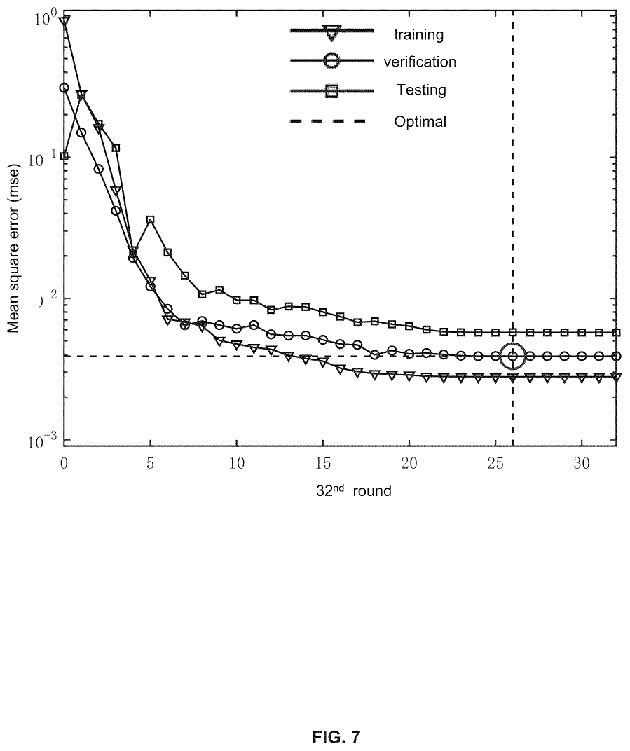

In some embodiments, the processor may determine the simulation result data based on the training dataset through the oil spill numerical model. For example, the processor may perform a three-dimensional numerical simulation based on the leakage time, the leakage aperture, the leakage velocity, the water flow velocity, etc., in the training dataset, and derive oil spill areas on sea surface under different influencing factors as the simulation result data. The processor may form a data table of the leakage time, the leakage aperture size, the leakage velocity, and the water flow velocity with the corresponding simulation result data. More about the data table may be found in Table 1 of FIG. 7 below and related notes.

The initial predictive model is the predictive model before training.

The predictive model refers to a model for predicting the oil spill area on sea surface. In some embodiments, the predictive model may be a machine learning model. For example, the predictive model may be a Convolutional Neural Network (CNN) model, Deep Neural Network (DNN) model, or any one or combination of such models. An input and an output of the predictive model may be described below.

The predetermined processing is a predetermined mode of processing the initial predictive model. In some embodiments, the predetermined processing may include training and dual verification, etc. The dual validation may include testing and verification. The training refers to model training of the initial predictive model based on certain training samples. The testing refers to testing of the initial predictive model after the training. The verification refers to verification of the initial predictive model after the training.

In some embodiments, the processor may obtain the predictive model by training based on a first training sample and a first label. In some embodiments, the first training sample may include the training dataset, and each set of data in the training dataset may include at least one of the leakage time, the leakage aperture, the leakage velocity, or the water flow velocity. The training label corresponding to each set of data in the training dataset may be the simulation result data corresponding to the each set of data in the data table.

In some embodiments, the processor may construct a loss function from the first training sample with the first label and the output of the initial predictive model, iteratively update the initial predictive model based on the loss function, and complete the training when the loss function of the initial predictive model satisfies a preset condition, wherein the preset condition may be that the loss function converges, a count of iterations reaches a threshold, etc.

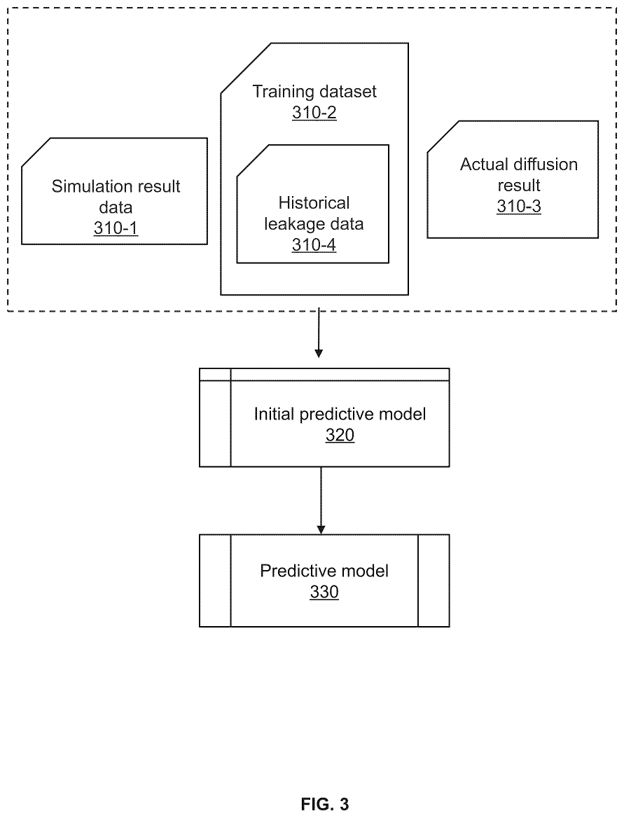

In some embodiments, the processor may also determine the predictive model by performing the predetermined processing on the initial predictive model based on the simulation result data, the training dataset, and an actual diffusion result, as more may be seen in FIG. 3 and the related description.

In some embodiments, the predetermined processing may include the training, testing, and verification, more of which may be seen in the related description above of FIG. 2. In some embodiments, the processor may also screen data satisfying the preset condition to train the initial predictive model among the simulation result data; and in response to a training result satisfying a training completion condition, determine that the training is completed. The processor may test the predictive model based on first remaining data to obtain accuracy of the predictive model; verify the predictive model based on second remaining data; and obtain that R correlation of the training, testing, and verification all exceeds a correlation threshold.

The data that satisfies the preset condition is a portion of all the simulation result data of the data table that satisfies the preset condition. In some embodiments, the processor may exclude data from all the simulation results data that satisfies the preset condition to obtain remaining data, and then divide the remaining data into the first remaining data and the second remaining data in a certain proportion. For example, the processor may determine half of the remaining data as the first remaining data and the other half as the second remaining data.

The preset condition may be that selected data accounts for not less than a ratio threshold of all simulation result data. For example, the ratio threshold may be 70%. The preset condition may be set artificially.

The initial predictive model may be obtained by training based on a sample and a label. The training sample includes the leakage time, the leakage aperture size, the leakage velocity, and the water flow velocity corresponding to the data that satisfies the preset condition in the data table, and the label is the corresponding data that satisfies the preset condition, i.e., the simulated value of the oil spill area on sea surface that satisfies the preset condition in the simulation result data. A similar training manner may be found in the above description.

The training result is a result after training the initial predictive model. The training completion condition is a condition reflecting completion of the training of the initial predictive model. The training completion condition may be set in advance. For example, the training completion condition may be set as the loss function converges, the count of iterations reaches a threshold, a difference between the output of the initial predictive model and the simulated result data does not exceed an error range, etc. The error range may be set as required. In response to the training result satisfying the training completion condition, the processor completes the training and obtains the predictive model.

In some embodiments, the processor may look up the data table based on the first remaining data to confirm the corresponding leakage time, leakage aperture size, leakage velocity, and water flow velocity, and input the leakage time, leakage aperture size, leakage velocity, and water flow velocity into a trained predictive model to obtain a first oil spill area on sea surface outputted by the predictive model.

The accuracy indicates how accurate the trained predictive model is.

In some embodiments, the processor may test the accuracy of the predictive model based on the first oil spill area on sea surface with the first remaining data. For example, the processor may calculate an absolute value of a difference between the first oil spill area on sea surface and the first remaining data, where the smaller the absolute value of the difference, the more accurate the predictive model is.

In some embodiments, the processor may confirm the corresponding leakage time, leakage aperture size, leakage velocity, and water flow velocity by looking up the data table based on the second remaining data, and input the leakage time, leakage aperture size, leakage velocity, and water flow velocity into the trained predictive model to obtain a second oil spill area on sea surface outputted by the predictive model.

In some embodiments, the processor may verify the accuracy of the predictive model based on the second oil spill area on sea surface with the second remaining data. For example, an absolute value of a difference between the second oil spill area on sea surface and the second remaining data is calculated, and the smaller the absolute value of the difference, the more accurate the predictive model.

The R correlation is a degree of linear correlation between data. Usually, the higher the R correlation, the stronger the linear correlation between the data. R greater than 0 indicates a positive correlation between the data; and R less than 0 indicates a negative correlation between the data.

The correlation threshold is a minimum value for determining the R correlation between data of the training, testing, and verification and simulation result data. The correlation threshold may be set empirically. For example, the correlation threshold may be set to 0.99.

In some embodiments, the trained predictive model is obtained when the training result, a testing result, and a verification result all exceed the correlation threshold. The training result is a simulated value of the oil spill area on sea surface outputted from training the initial predictive model. The test result is the first oil spill area on sea surface obtained by testing the trained predictive model. The verification result is the second oil spill area on sea surface outputted by verifying the trained predictive model.

In some embodiments, an overall error value between the simulation result data and a preset calculation software needs to be kept within a predetermined range, and overall R correlation exceeds the correlation threshold. The predetermined range may be set empirically. For example, the predetermined range may be set from −0.15 to +0.10.

The predetermined calculation software is predetermined software that may perform calculations based on the training dataset and output a calculation result. For example, the predetermined software may include MATLAB software, etc. The calculation result is a reference value of a calculated oil spill area on sea surface.

Some embodiments of the present disclosure can improve the accuracy of the simulation result data by comparing the simulation result data with the calculation result of the predetermined software and controlling an error between the simulation result data and the calculation result. Thus, the accuracy and reliability of the predictive model obtained by training based on the simulation result data can be improved. This demonstrates the reliability and accuracy of the constructed predictive model in predicting oil spill accidents, enabling quick grasp of a size of an oil film area on sea surface after an accident of pipeline leakage.

Some embodiments of the present disclosure train, test, and verify the initial predictive model through the simulation result data, and the testing and verification process may be viewed as the dual verification of the model, thereby improving the accuracy and reliability of the predictive model obtained by training.

Step S3, initializing the predictive model, determining a count of nodes of an input layer, an output layer, and a hidden layer, wherein an input of the input layer is the training dataset, the oil spill area on sea surface is an output of the output layer, and the count of nodes of the hidden layer is related to at least one of the count of nodes of the input layer and the count of nodes of the output layer.

In some embodiments, the processor may initialize the trained predictive model in a variety of initialization approaches. For example, the initialization approaches may include all-zero initialization, random initialization, etc. There is no restriction on the initialization approach here.

The input layer is a layer in the predictive model used for inputting a parameter. In some embodiments, the input of the input layer of the predictive model may include at least one of the leakage time, the leakage aperture size, the leakage velocity, or the water flow velocity. When training the predictive model, the input of the input layer of the initial predictive model is the training dataset.

The output layer is a layer in the predictive model used to output the parameter. In some embodiments, an output value of the output layer of the predictive model includes the oil spill area on sea surface.

The oil spill area on sea surface is an area of a sea surface covered by leaked oil. In some embodiments, the oil spill area on sea surface may include the oil film area on sea surface. The oil film area on sea surface is an area of an oil film formed by oil spill to the sea surface.

The hidden layer is an intermediate portion of a layer structure excluding the input layer and the output layer. In some embodiments, the count of nodes of the hidden layer is related to at least one of the count of nodes of the input layer and the count of nodes of the output layer.

The nodes refer to neurons in a neural network model. The count of nodes refers to a count of the neurons.

The count of nodes of the input layer refers to a quantity of nodes of the input layer. The count of nodes of the input layer may be determined based on a count of features of the input layer. The count of features is a count of parameters contained in the layer structure. For example, if the input parameters of the input layer are the leakage time, leakage aperture size, leakage velocity, and water flow velocity, the count of features of the input layer is 4, i.e., the count of nodes of the input layer is 4.

The count of nodes of the output layer is a quantity of nodes of the output layer. The count of nodes of the output layer may be determined based on a count of features of the output layer. For example, if the output parameter of the output layer is the oil spill area on sea surface, the count of features of the output layer is 1, which means that the count of nodes of the output layer is 1.

In some embodiments, the processor may determine the count of nodes of the hidden layer based on the count of nodes of the input layer, and the count of nodes of the output layer. For example, the count of nodes of the implicit layer may be determined by the following formulas (1), (2), (3):

m=\sqrt{n+l} (1)

m=\sqrt{nl} (2)

m=2n+1 (3)
where n is the count of nodes of the input layer, m is the count of nodes of the hidden layer, and is the count of nodes of the output layer.

In some embodiments, the processor may determine a value of m corresponding to a smallest mean square error of a calculated result as the count of nodes of the hidden layer. Exemplarily, when n is taken to be 4 and is taken to be 1, the mean square error of the calculated result is taken to be the smallest value of 2, which means that the count of nodes of the hidden layer is determined to be 2. The above values are taken only as examples, and the values of m, n, are not qualified here.

Step S4, obtaining input data and inputting the input data into the predictive model in S2 to obtain an oil spill area on sea surface to be measured.

The input data is data related to a leakage to be tested in the submarine oil pipeline. In some embodiments, the input data may include the leakage time, leakage aperture size, leakage velocity, and water flow velocity, etc.

In some embodiments, the processor may obtain input data via the user terminal, as described above.

The oil spill area on sea surface to be measured is an area of the oil spill on the sea surface pending to be measured and confirmed.

In some embodiments, the processor may determine the oil spill area on sea surface to be measured based on the leakage time, leakage aperture size, leakage velocity, water flow velocity, etc., by means of the predictive model.

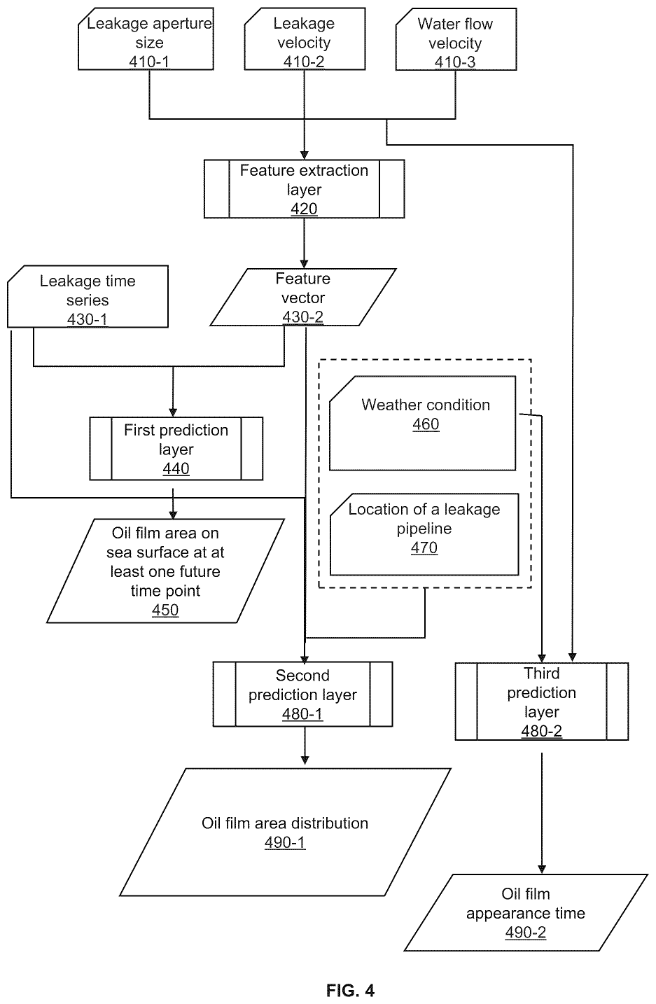

In some embodiments, the processor may also determine the oil film area on sea surface at at least one future time point through a feature extraction layer of the predictive model and a first prediction layer, as may be seen in FIG. 4 and the related description.

In some embodiments of the present disclosure, the predictive model is obtained by performing the predetermined processing on the constructed initial predictive model, and based on the predictive model, the oil spill area on sea surface is predicted, and the prediction result has a small error and a high degree of accuracy, and the actual measured oil film area on sea surface and simulated value after the incidence of an accident may be kept within a controllable range. Furthermore, the oil film area on sea surface after the oil spill accident can be better predicted, providing data support for subsequent emergency response measures to sudden oil spill accidents.

It should be noted that the foregoing description of the process 200 is intended to be exemplary and illustrative only and does not limit the scope of application of the present disclosure. For those skilled in the art, various corrections and changes may be made to the process 200 under the guidance of the present disclosure. However, these corrections and changes remain within the scope of the present disclosure.

FIG. 3 is an exemplary schematic diagram of determining a predictive model according to some embodiments of the present disclosure.

In some embodiments, a training dataset 310-2 may include historical leakage data 310-4. In some embodiments, the processor may determine a predictive model 330 based on simulation result data 310-1, the training dataset 310-2, and an actual diffusion result 310-3, by performing a predetermined processing on an initial predictive model 320. A ratio of a first sample count of the simulation result data to a second sample count of the actual diffusion result is determined based on a test feature.

The historical leakage data refers to data collected when a historical oil leakage occurred. For example, the historical leakage data may include a historical leakage aperture size, a historical leakage velocity, a historical water flow velocity, etc., that were collected when the oil leakage occurred at a historical leakage time. The historical leakage data may be obtained by detection of sensors for detecting various types of parameters associated with the oil leakage.

In some embodiments, the historical leakage data may be collected by a detection device and/or a plurality of movable standby detection devices.

The detection device is a device that is used to detect leakage from an oil pipeline. The movable standby detection device is a device that may be freely moved and perform auxiliary detection. The detection device may be configured as a plurality of sensor devices, gauges, or the like. For example, the sensor devices may include laser profile sensors, flow rate sensors, or the like. The movable standby detection devices may be configured as a plurality of sensors capable of moving freely in a marine environment for collecting and monitoring environmental data and information on a seafloor. Typically, the sensors are characterized by buoyancy, stability, and seabed adaptability; the ability to remain stable while moving underwater; and the availability of an energy source and an electrical system that allows for continuous operation.

In some embodiments, the detection device and the standby detection devices are placed in the vicinity of submarine oil pipelines. In some embodiments, a particular detection device is used as a primary detection device when it first detects a leakage in an oil pipeline. The processor may invoke the plurality of movable standby detection devices, controlling them to move to a location of the leakage for secondary detection.

In some embodiments, a count of the detection devices and standby detection devices may be determined in advance based on experience. In some embodiments, a count of the standby detection devices may be determined based on submarine environment in which a historical leakage pipeline is located, as described below.

Some embodiments of the present disclosure, where data is collected by the detection device and the plurality of movable standby detection devices, allow for freedom of movement and deployment of the devices, thereby providing more comprehensive and accurate historical leakage data.

In some embodiments, the count of the standby detection devices may be determined based on the submarine environment in which a historical leakage pipeline is located. The historical leakage pipeline is a pipeline that has had an oil leakage at a historical time point or during a historical time period.

In some embodiments, the submarine environment may include at least one of a water depth, a pressure, a seawater temperature, a salinity, a water flow velocity, a submarine topography measurement result, a submarine geologic survey result, etc.

The water depth is a depth of seawater at which the leakage pipeline is located. The pressure is a value of seawater pressure at the leakage pipeline. The seawater temperature is a temperature of the seawater at the leakage pipeline. The salinity is a salinity value of the seawater at the leakage pipeline. The water flow velocity is a flow velocity of the seawater at the leakage pipe.

In some embodiments, the submarine topography measurement result may include topographic relief, estuaries, submarine obstructions, etc. The processor may obtain the submarine topography measurement result from high-precision measurements of the submarine topography along the submarine pipelines by a measurement device, such as a multi-beam sonar or a laser scanning system.

In some embodiments, the submarine geological survey result may include terrain stability, geological formations, geological risks, etc. The processor may obtain the submarine geological survey result by evaluating submarine geological conditions through bedrock sampling, acoustic propagation testing, and geological exploration equipment.

In some embodiments, the processor may determine a submarine environment complexity based on the submarine environment in which the historical leakage pipeline is located via a preset relationship. The processor may determine the count of the standby detection devices based on the submarine environment complexity. The preset relationship is a relationship between the submarine environment and the submarine environment complexity, and the preset relationship may be set artificially. The submarine environment complexity may be positively correlated with the count of the standby detection devices. For example, the greater the submarine environment complexity, the greater the count of the standby detection devices determined by the processor.

In some embodiments of the present disclosure, by analyzing the submarine environment in which the historical leakage pipeline is located to determine the count of the standby detection devices, the processor may determine different counts of the standby detection devices based on different environmental conditions, making the allocation and use of the standby detection devices more reasonable. For cases where the submarine environment is less complex, the processor may allocate a smaller count of the standby detection devices, saving resources.

In some embodiments, the historical leakage data may include calibrated data. The calibrated data refers to calibrated historical leakage data.

In some embodiments, the processor may obtain first detection data of the detection device. The processor may obtain second detection data of the standby detection devices. The processor may obtain the calibrated data by performing comprehensive processing on the first detection data and the second detection data.

The first detection data is the historical leakage data obtained by the detection device. The second detection data is the historical leakage data obtained by the standby detection devices. The plurality of standby detection devices may obtain a plurality of sets of second detection data. The first detection data and the plurality of sets of second detection data are the same as the data contained in the training dataset, i.e., each set of data corresponding to the first detection data and the plurality of sets of second detection data includes a leakage time, a leakage aperture size, a leakage velocity, a water flow velocity, etc.

The comprehensive processing refers to one or more manners of processing the first detection data and the second detection data. In some embodiments, the comprehensive processing may include averaging, etc. In some embodiments, the processor may take an average of the first detection data and the plurality of sets of second detection data for the same leakage time as the calibrated data.

In some embodiments, the comprehensive processing includes weighting. The processor may determine the calibrated data based on the first detection data and a corresponding first weight, and a plurality of pieces of second detection data and corresponding second weights. For example, the processor may determine the calibrated data based on a formula (4):

calibrated data=a x first detection data+b₁ x second detection data 1+b₂ x second detection data 2+ . . . +bₙ x second detection data n (4)
wherein, a is the first weight, and b₁, b₂ . . . , and bₙ represent a plurality of second weights corresponding to the plurality of pieces of second detection data, respectively.

In some embodiments, the first weight for the first detection data and the plurality of second weights for the plurality of pieces of second detection data are determined based on detection device data.

The detection device data refers to data related to the detection devices. In some embodiments, the detection device data may include performance parameters, overhaul data, etc., of the detection device and/or the plurality of the standby detection devices. The performance parameters may include at least one of sensitivity, stability, or the like, of the detection device and/or the plurality of backup detection devices. The overhaul data may include at least one of a previous overhaul time, a historical overhaul problem type, a device usage time, etc., of the detection device and/or the plurality of the standby detection devices.

In some embodiments, the processor may determine a performance score for each detection device and each standby detection device based on the detection device data by looking up a score table. The processor may determine the first weight and the plurality of second weights based on performance scores.

In some embodiments, the score table may be constructed based on the detection device data and the performance scores from historical data. Each set of the second detection data corresponds to a second weight, respectively. In some embodiments, the processor may determine the first weight and the plurality of second weights in accordance with a ratio of performance scores. For example, if the processor looks up the score table and determines that the performance scores of the detection device and two standby detection devices are 8, 6, and 6, respectively, the ratio of the performance scores is 4:3:3, which corresponds to a first weight of 40% and two second weights of 30%, 30%, respectively.

In some embodiments of the present disclosure, the first weight and the second weight are determined based on the detection device data, so that the detecting device or the standby detecting devices with better performance correspond to larger weights so that the accuracy and the reliability of the obtained calibrated data can be improved to further improve the accuracy of prediction by the predictive model.

Some embodiments of the present disclosure, by calibrating the detection data of the detecting device and the standby detection devices to obtain the calibrated data, errors due to the performance of the devices and the difference between different devices can be reduced, and the accuracy of obtained data can be improved. This is conducive to improving the accuracy of the obtained predictive model, as well as subsequent handling of oil spill accidents.

The actual diffusion result refers to a result of the actual diffusion of oil on sea surface at a time of a historical oil leakage, for example, an area of oil film that actually diffuses. In some embodiments, the actual diffusion result and the historical leakage data, etc., may also be saved in a data table.

In some embodiments, the processor may perform the predetermined processing (e.g., training, testing, verification, etc.) on the initial predictive model based on a first sample, a second sample, the simulation result data of a first sample count, and an actual diffusion result of a second sample count, to determine the predictive model. Related content on the training, testing, and verification may be found in FIG. 2 and related description. The first sample and the second sample may be determined by looking up the data table. Details on the data table may be found in FIG. 2 and related descriptions.

The first sample count refers to a count of the first samples used in the training process. The second sample count refers to a count of the second samples used in the training process. The first sample is the training dataset corresponding to the simulation result data in the data table. The second sample is the training dataset corresponding to the actual diffusion result in the data table. More about the data table may be found in FIG. 2 and related descriptions.

In some embodiments, the ratio of the first sample count to the second sample count is the same during the training, testing, and verification.

In some embodiments, the ratio of the first sample count to the second sample count may be determined based on a test feature. The test feature is a feature reflecting how the first sample is related to the second sample. The test feature may include a sample distribution feature, a test accuracy feature, etc.

The sample distribution feature refers to a feature that reflects a distribution of the first sample and the second sample. In some embodiments, the sample distribution feature may include a grouping situation of the second samples, associated samples corresponding to each set of the second samples, samples to be adjusted, or the like.

The grouping situation of the second samples is determined based on the leakage time. The leakage time refers to the duration of a leakage. For example, the processor may divide the leakage time into a plurality of leakage time periods of a preset length (e.g., 0 to 1 hour, 1 to 2 hours, 2 to 3 hours, . . . ). In some embodiments, the processor may divide a plurality of second samples within a same leakage time period into a set.

The associated samples refer to the first samples corresponding to each set of the second samples, i.e., the first samples that are within the same leakage period as the second samples. The samples to be adjusted refer to first samples to be adjusted. The samples to be adjusted include remaining first samples in the first sample other than the associated samples (i.e., first samples that are in a different leakage time period than the second samples).

The test accuracy feature is a metric reflecting accuracy of a test of the predictive model based on the first sample and the second sample. In some embodiments, the test accuracy feature includes a composite difference. The composite difference is used to reflect an overall accuracy difference between the first sample and the second sample. In some embodiments, the processor may calculate an accuracy difference between the associated samples and the second samples for each set separately; and based on a plurality of accuracy differences, obtain the composite difference through a weighted average. A weight corresponding to the accuracy difference for each set of samples may be determined based on the leakage time period corresponding to that set of samples. The farther the leakage time period is from an initial leakage time, the smaller the corresponding weight. The initial leakage time is a time when the submarine pipeline first started leaking oil, i.e., hour 0.

In some embodiments, the processor may adjust the first sample count when the composite difference exceeds a difference threshold; and determine the ratio of the first sample count to the second sample count based on an adjusted first sample count. The difference threshold may be set in advance, and the difference threshold is positively correlated with the second sample count.

In some embodiments, the processor may adjust the first sample count based on the composite difference. For example, the greater the composite difference, the greater the amount of adjustment of the samples to be adjusted, and the smaller the first sample count. The amount of adjustment is a reduction in the samples to be adjusted. The amount of adjustment may be determined based on a predetermined correspondence between the composite difference and the amount of adjustment. The predetermined correspondence may be set artificially.

In some embodiments of the present disclosure, the training dataset includes the historical leakage data, and the actual diffusion result is also used as the label during the training of the initial predictive model, which can improve the training effect of training the initial predictive model, so that the initial predictive model training process can grasp the prediction effect on the real diffusion situation. This improves the prediction accuracy of the predictive model subsequently.

FIG. 4 is an exemplary flowchart of determining an oil film area on sea surface according to some embodiments of the present disclosure.

In some embodiments, a predictive model may include a feature extraction layer 420 and a first prediction layer 440.

In some embodiments, the feature extraction layer 420 may be a machine learning model, e.g., the feature extraction layer 420 may be a convolutional neural network model (CNN) or the like, or any combination of other customized model structures.

In some embodiments, an input of the feature extraction layer 420 includes a leakage aperture size 410-1, a leakage velocity 410-2, and a water flow velocity 410-3, and an output of the feature extraction layer 420 is a feature vector 430-2. The feature vector 430-2 is a vector used to characterize information such as the leakage aperture size, the leakage velocity, the water flow velocity, or the like.

The leakage aperture size 410-1 refers to a size of an aperture of a hole at an oil leakage. A scale of the leakage aperture size may include millimeters, centimeters, meters, etc. The processor may obtain the leakage aperture size based on a plurality of feasible ways. For example, the leakage aperture size may be obtained based on a direct measured by a device such as a scale measuring instrument. For example, the leakage aperture size may also be obtained based on capture by a filming device (e.g., a webcam, etc.) and amplification by scale calculation.

The leakage velocity 410-2 refers to a magnitude of a velocity at which oil leaks into the sea. The magnitude of the leakage velocity may be quantified by a flow velocity representation. In some embodiments, the processor may obtain the leakage velocity based on any feasible means. For example, the processor may determine the leakage velocity based on a difference in flow velocities of oil in a pipeline at locations before and after a leakage location. The flow velocities of oil in the pipeline at the locations before and after the leakage location is obtained by calculation through a formula based on a flow volume captured by flow meters set inside the pipeline at the locations before and after the leakage location, e.g., flow velocity (m/s)=flow volume (m³/s)/pipeline cross-sectional area (m²). Common types of flowmeters include at least one of a turbine flowmeter, an electromagnetic flowmeter, an ultrasonic flowmeter, etc.

The water flow velocity 410-3 refers to a flow velocity of seawater at the leakage location. For example, the water flow velocity may be expressed as 2 m/s, etc. In some embodiments, the processor may obtain the water flow velocity based on a water flow velocity measurement device. For example, the water flow velocity may be obtained based on detection by the water flow velocity measurement device (e.g., a flow velocity detector, etc.) installed on a submarine oil pipeline.

In some embodiments, the first prediction layer 440 may be a machine learning model, e.g., the first prediction layer 440 may be a neural network model (NN), etc., or other customized modeling structure, etc., of any one or a combination thereof.

In some embodiments, an input of the first prediction layer 440 includes a leakage time series 430-1 and the feature vector 430-2, and an output of the first prediction layer 440 is an oil film area on sea surface at at least one future time point 450.

A leakage time refers to a time period from the start of the leakage to a certain time point during a leakage process. The leakage time series 430-1 refers to a data sequence consisting of a plurality of sets of leakage times of different lengths. Each element in the leakage time series may represent a leakage time of a different length.

At least one future time point refers to one or more time points in the future from a time point when the leakage occurred. In some embodiments, the processor may predetermine the at least one future time point based on practical needs. In some embodiments, the at least one future time point corresponds to the leakage time series. For example, the at least one future time point corresponds to each leakage time in the leakage time series, respectively.

The oil film area on sea surface at the at least one future time point refers to a sea area covered by floating oil resulting from the leakage at one or more future time points. The oil film area on sea surface at the at least one future time point is in dynamic change, generally in an expansion trend, and is subject to fluctuations due to ocean currents, weather changes, and other factors.

In some embodiments, the feature extraction layer 420 and the first prediction layer 440 may be obtained by joint training based on a large count of second training samples with a second label.

In some embodiments, the second training sample may include a sample leakage aperture size, a sample leakage velocity, a sample water flow velocity, and a sample leakage time series for a first historical time point. The second label includes an oil film area on sea surface at a second historical time point. The second historical time point is later in chronological order than the first historical time point.

In some embodiments, the second training sample may be obtained directly through the training dataset. The second training samples in the training dataset consist of two parts, including actual data collected by a detection device and/or a standby detection device when an oil pipeline leakage occurs at the first historical time point, and simulated data obtained based on simulation through an oil spill numerical model. The second label may likewise be obtained directly from the training dataset. The second label in the training dataset includes an oil film area on sea surface during a real leakage at the second historical time point, and an oil film area on sea surface obtained from the simulation of the second training sample.

In some embodiments, a loss function may be constructed from the second label and an output result of an initial feature extraction layer and an initial first prediction layer, and the initial feature extraction layer and the initial first prediction layer are iteratively updated based on the loss function, and the training is completed when the initial feature extraction layer and the loss function of the initial first prediction layer satisfy a preset condition, wherein the preset condition may be that the loss function converges, a count of iterations reaches a threshold, etc.

In some embodiments of the present disclosure, by introducing the feature extraction layer and the first prediction layer, the feature vector and the oil film area on sea surface obtained by through prediction are more accurate and reliable, and data processing efficiency is greatly improved, providing comprehensive and reliable data support for subsequent analysis of leakage accident situations and optimization of treatment measures. Some embodiments of the present disclosure can determine the oil film area on sea surface at at least one future time point, which reduces an influence of a chance factor brought by the sample being too small compared to only determining the oil film area on sea surface at one future time point, making the calculation result more comprehensive and reliable.

In some embodiments, the predictive model further includes a second prediction layer 480-1. In some embodiments, the processor may determine an oil film area distribution 490-1 at the at least one future time point through the second prediction layer 480-1 based on the feature vector 430-2, the leak time series 430-1, a weather condition 460 in a future time period, and a location of a leakage pipeline 470.

In some embodiments, the second prediction layer 480-1 may be a machine learning model, e.g., the second prediction layer 480-1 may be a Long Short-Term Memory (LSTM) network, etc. or any one of other customized model structures, etc. or a combination thereof.

In some embodiments, an input of the second prediction layer 480-1 includes the leakage time series 430-1, the feature vector 430-2, the weather condition 460 in the future time period, and the location 470 of the leakage pipeline, and an output of the second prediction layer 480-1 is the oil film area distribution 490-1 at the at least one future time point.

The weather condition 460 in the future time period refers to a weather condition in a relevant sea area at one or more future time points from a time point when the leakage occurred. In some embodiments, the weather condition in the future time period includes at least one or a combination of indicators such as precipitation, wind velocity, temperature, humidity, etc.

The weather condition in the future time period may be obtained through a variety of feasible ways. In some embodiments, the processor may obtain the weather condition in the future time period based on a plurality of detecting devices (e.g., temperature and humidity sensors, wind velocity meters, etc.) that detect the indicators. In some embodiments, the processor may also obtain the weather condition in the future time period based on a third-party data platform and/or a website, e.g., the third-party data platform and/or the website may include a weather forecasting network or the like.

The location of the leakage pipeline is a specific location of the pipeline where the leakage occurred. The location of the leakage pipeline may be represented based on a variety of feasible ways. In some embodiments, the location of the leakage pipeline may be represented based on a pre-determined pipeline label and a zone number for a specific pipeline. In some embodiments, the location of the leakage pipeline may also be represented based on positional coordinates of the pipeline's leakage point obtained by a satellite positioning system.

The location of the leakage pipeline may be obtained based on a variety of ways. In some embodiments, the processor may capture and determine the location of the leakage pipeline through sensing devices installed on various parts of the submarine oil pipeline (e.g., sonar detectors, water pressure sensors, etc.) based on changes in the water flow velocity and water pressure around the pipeline. In some embodiments, the location of the leakage pipeline may also be determined based on a manual survey.

The oil film area distribution refers to a regional distribution of oil film formed on the sea surface by oil at at least one future time point after a leakage occurs. For example, the oil film area distribution may include such things as division of the oil film into regions, a total area of the sea area surrounded by the oil film regions, a degree of deviation from a location of the leakage, etc. The degree of deviation from the location of the leakage refers to a degree of proximity of the oil film to the location of the leakage. In some embodiments, the processor may obtain a distance of each oil film region's center location relative to the location of the leakage, and take an average value of the distances as the degree of deviation from the location of the leakage.

The oil film area distribution may be obtained in any feasible manner. In some embodiments, the processor may obtain the oil film area distribution based on at least one of satellite remote sensing technology, shipboard and/or airborne sensing devices, ocean modeling, and drift simulation, or a plurality of means of any combination thereof to obtain the oil film area distribution.

In some embodiments, the feature extraction layer 420 and the second prediction layer 480-1 may be obtained by joint training based on a large count of third training samples with a third label.

In some embodiments, the third training sample may include a sample leakage aperture size, a sample leakage velocity, a sample water flow velocity, a sample leakage time series, a sample weather condition during a historical time period, and a location of a sample leakage pipeline at a third historical time point. The third label includes an oil film area distribution at a fourth historical time point. The fourth historical time point is chronologically later than the third historical time point.

In some embodiments, the third training samples may be obtained directly from the training dataset. The third training samples in the training dataset consist of two parts, including actual data collected by the detection device and/or the standby detection device when an oil pipeline spill occurs at the third historical time point and simulated data obtained based on simulation through the oil spill numerical model. The third label may be obtained directly from the training dataset. The third label in the training dataset includes the oil film area distribution during the real leakage at the fourth historical time point and an oil film area distribution obtained through simulation by the oil spill numerical model.

Regarding the joint training of the feature training layer and the second prediction layer in a manner similar to the joint training of the feature training layer and the first prediction layer, a related description may be found in the preceding corresponding section.

In some embodiments of the present disclosure, the oil film area distribution at the at least one future time point is predicted to be obtained by setting the second prediction layer, which improves the accuracy and efficiency of the prediction, enables the leakage handler to quickly obtain more comprehensive oil film-related information, and can provide accurate data support for the subsequent processing work.

In some embodiments, the predictive model further includes a third prediction layer 480-2. In some embodiments, the processor may determine an oil film appearance time 490-2 through the third prediction layer 480-2 based on the leakage aperture size 410-1, the leakage velocity 410-2, the water flow velocity 410-3, and the weather condition 460 in the future time period.

In some embodiments, the third prediction layer 480-2 may be a machine learning model, e.g., the third prediction layer may be any one or a combination of a neural network model (NN), other customized modeling structures, etc.

In some embodiments, an input of the third prediction layer 480-2 includes the leakage aperture size 410-1, the leakage velocity 410-2, the water flow velocity 410-3, and the weather condition 460 in the future time period, and an output of the third prediction layer 480-2 is the oil film appearance time 490-2.

See FIG. 4 above for a description of the leakage aperture size, the leakage velocity, and the water flow velocity.

The oil film appearance time refers to a period of time elapsed from a start of the leakage to a time when oil begins to appear on the sea surface. For example, the oil film appearance time is a length of time elapsed from the start of the leakage at a leakage location to the time when detectable oil appears on the sea surface of at the leakage location and in the surrounding sea.

In some embodiments, the third prediction layer 480-2 may be obtained based on a large count of fourth training samples trained with a fourth label. Each set of the fourth training samples may include a sample leakage aperture size, a sample leakage velocity, a sample water flow velocity, and a sample weather condition in a historical time period. The fourth training label includes the oil film appearance time at the second historical time point. The second historical time point is chronologically later than the first historical time point. The fourth training samples and the fourth label are obtained in a similar manner as the second training samples and the second label, as described in the relevant description in the preceding corresponding section.

A training manner of the third prediction layer is similar to the training manner of the predictive model, as described in the corresponding section of FIG. 2.

In some embodiments of the present disclosure, predicting the oil film appearance time by setting the third prediction layer is beneficial for determining the time when the oil film begins to appear on the sea surface after the pipeline leakage, facilitating subsequent arrangements for recycling operations etc.

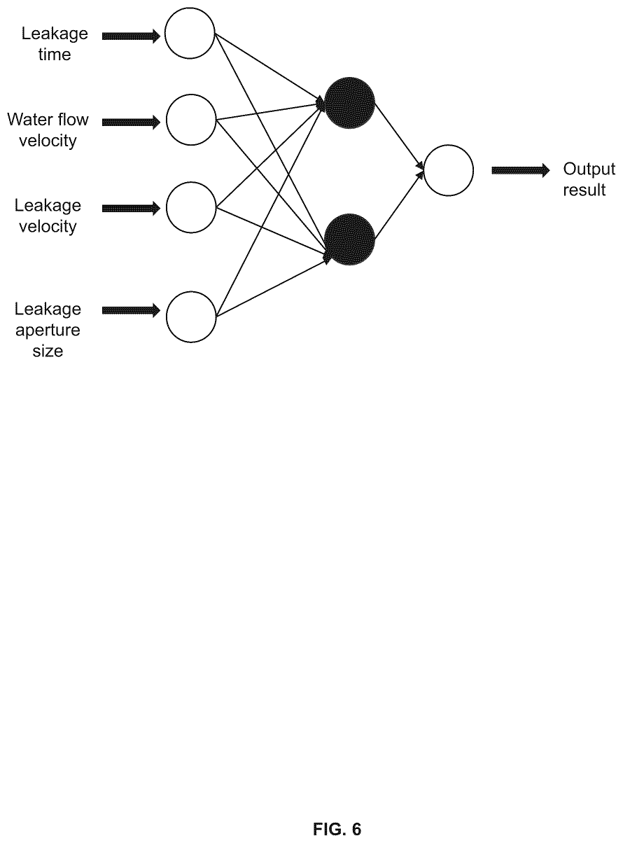

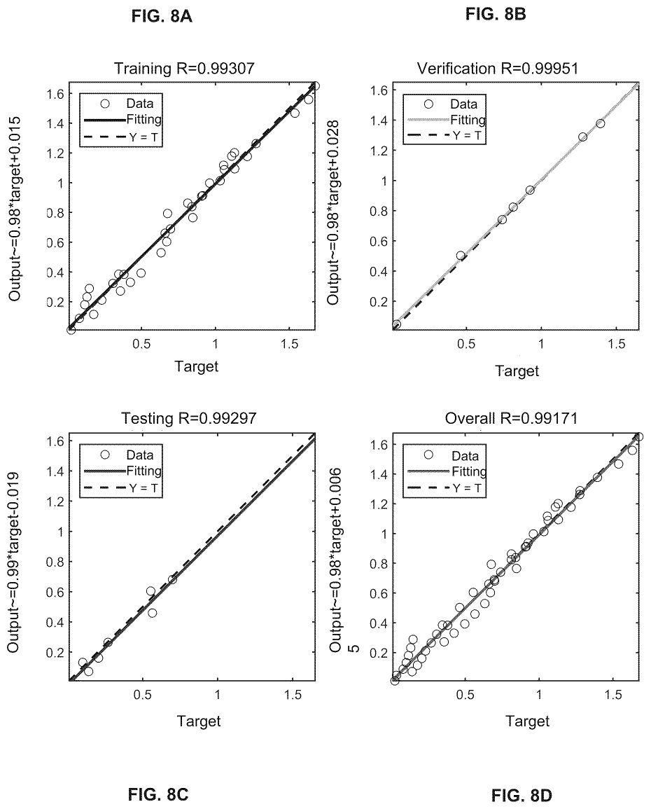

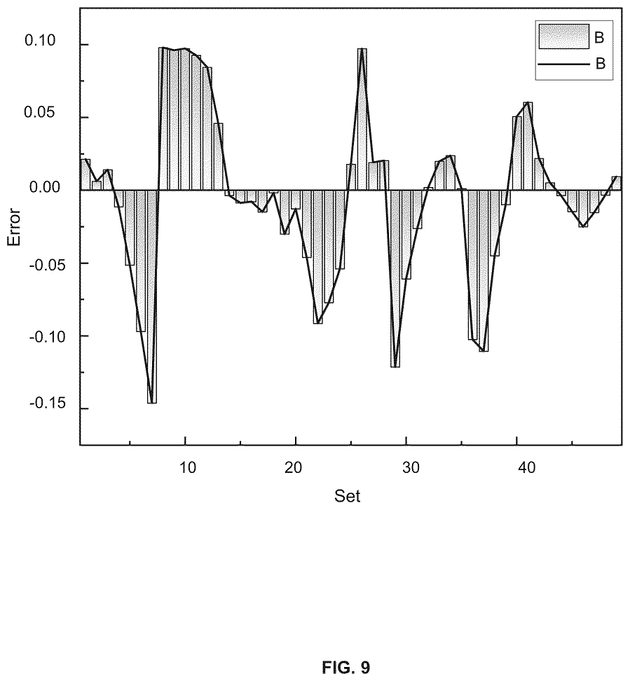

FIG. 5 is an exemplary schematic diagram of a process for predicting an oil spill area on sea surface according to some embodiments of the present disclosure. FIG. 6 is a topology diagram of a predictive model for predicting an oil film diffusion area on sea surface according to some embodiments of the present disclosure. FIG. 7 is a performance diagram of mean squared error (MSE) metrics for a training process according to some embodiments of the present disclosure. FIG. 8A is an exemplary schematic diagram of a first kind of fit curves of the predictive model according to some embodiments of the present disclosure. FIG. 8B is an exemplary schematic diagram of a second kind of fit curves of the predictive model according to some embodiments of the present disclosure. FIG. 8C is an exemplary schematic diagram of a third kind of fit curves of the predictive model according to some embodiments of the present disclosure. FIG. 8D is an exemplary schematic diagram of a fourth kind of fit curves of the predictive model according to some embodiments of the present disclosure. FIG. 9 is a test error diagram of an oil spill area according to some embodiments of the present disclosure.

S11, collecting data to form a dataset, which includes influencing factors that affect the oil spill area on sea surface formed by the leakage of the submarine oil pipeline, and using the dataset as a component of a predictive model;

S12, constructing a three-dimensional oil spill numerical model of the submarine pipeline based on a computational fluid dynamics (CFD) software platform, forming a data table, and conducting training, testing, and verification on data formed from a numerical simulation result to dual-verify accuracy of the predictive model, and finally determining the predictive model;

S13, initializing the predictive model, determining a count of metrics of an input layer, an output layer, and a hidden layer, wherein the dataset is an input of the input layer, the oil spill area on sea surface is an output, and a count of nodes of the hidden layer is determined according to a formula:

m=\sqrt{n+l}

m=\sqrt{nl}

=2n+1
wherein, n denotes the count of input layers, m denotes the count of hidden layers; I denotes the count of output layers, and a minimum value of mean-square errors of the calculation results is taken to determine the count of metrics of the hidden layer as 2;
S14, determining input data, and inputting the input data into the predictive model to obtain an oil spill area on sea surface to be measured.

In some embodiments, the dataset in the data collection is not limited to a specific data source.

In some embodiments, conducting training, testing, and verification on data formed from a numerical simulation result in step S12 includes inputting numerical values of the influencing factors influencing the formation of the oil spill area on sea surface from by the leakage of the submarine oil pipeline into a trained predictive model, and obtaining the oil spill area on sea surface to be measured through the trained predictive model. At least 70% of the data from the numerical simulation result is selected to construct the predictive model and data training is conducted. If a training result does not exceed an error range, the training is completed, and after the completion of the training, half of remaining data is verified, so as to verify the accuracy of the predictive model. Then the other half of the remaining data is tested, and it is obtained that R correlation of the training, testing, and verification all exceed 0.99.

In some embodiments, an error between a simulated oil film area on sea surface in step S12 and an overall calculated value of the MATLAB software is maintained between −0.15 and +0.10, and the overall R correlation is over 0.99, which once again demonstrates the reliability and accuracy of the constructed predictive model for predicting oil spill accidents, and the ability to quickly grasp the size of the oil film area on sea surface after the pipeline leakage occurs.

As shown in FIGS. 5-9, the method for predicting the oil spill area on sea surface includes the following specific steps:

S11, collecting data. The processor collects data. The processor may take the influencing factors affecting the oil spill area on sea surface formed by the leakage of the submarine pipeline as the dataset to be collected, and the dataset includes different leakage times, different leakage apertures (leakage aperture sizes), different leakage velocities, different water flow velocities, and other comprehensive factors. Depending on different influencing factors, e.g., sunny, cloudy, overcast, low sunlight, etc., ocean current velocities vary, and the specifics may vary according to individual research. The data here is not limited to a specific source and may include calculated data or arbitrary inputted data. For example, the simulation data from computer simulation sources may be experimental data from a laboratory, measured engineering data, etc.

Organizing data in S11. The processor organizes the influencing factors such as the water flow velocity, the leakage velocity, the leak aperture size, the leakage time, and the size of the oil film area on sea surface as components of the predictive model.

S12, performing a three-dimensional numerical simulation (three-dimensional oil film diffusion simulation on water surface) based on the Fluent software to study influences of the leakage velocity, the water flow velocity, and the leakage aperture on the oil spill area on sea surface formed by the leakage of the submarine oil pipeline. A numerical simulation model is combined with the actual situation, using a volume of fluid (VOF) approach of a multiphase model in conjunction with a Standardk-ε turbulence model and a pressure-implicit with splitting of operators (PISO) algorithm. Taking the submarine pipeline as an example, a similarity ratio between the model and an actual diameter is 1:12.41, and a leakage time ratio is 1:112.41. The simulation sets a wind velocity to 0. Taking an ocean island as an example, an inner diameter of a single-layer oil pipeline from the island to land is 610 mm (24 inches), and based on an actual situation, a similarity ratio of the model to a diameter of a prototype pipeline is 1:12.41;

According to a determined diameter and length of the pipeline, the processor establishes a three-dimensional model of the leakage aperture of the pipeline based on the Workbench software, uses the ICEM CFD software to carry out unstructured meshing for the model, and encrypts a mesh at the leakage aperture by modifying a size of the mesh based on a leakage aperture size, and outputs a mesh file.

The processor imports the mesh file into a Fluent solver, uses Fluent to check whether the mesh size in the mesh file meets a condition required for the simulation, turns on gravity, sets gravitational acceleration, and sets components, boundary conditions, a solution model, and a solution algorithm for the solution model. The magnitude of gravity is set based on local gravitational acceleration. The components are air and crude oil. Based on a simulation result of the Fluent software, sizes of oil film area on sea surface under conditions of different influencing factors are derived, and 49 sets of simulated data are obtained, as shown in Table 1 below. The simulated data provides data support for handling oil leakage accidents under different influencing factors and serves as a basis for handling oil spill accidents on sea surface.

S13, initializing the predictive model to determine a count of metrics of an input layer, an output layer, and a hidden layer. The input layer includes the influencing factors such as the leakage time, the leakage aperture size, the leakage velocity, the water flow velocity, etc. Since the formation of oil films on sea surface due to submarine oil spills is a primary factor contributing to environmental pollution, determining the size of the oil film area on sea surface is of paramount importance in managing oil spill accidents. Therefore, an output value (output result) is set as the oil film area on sea surface due to the oil spill. Subsequently, the count of nodes of the hidden layer is determined to be 2 finally using the golden section approach and adjusting, which is primarily based on the formula:

m=\sqrt{n+l}

m=\sqrt{nl}

m=2n+1

wherein, n denotes the count of the input layers, m denotes the count of the hidden layers; I denotes the count of the output layers, a minimum value of a mean square error of the calculation result is taken to determine the count of indicators of the hidden layer to be 2. The topology of the predictive model is shown in FIG. 6.

S14, determining input data and inputting the input data into the predictive model in S12 to obtain the oil film area on sea surface to be measured.

According to step S12, 49 sets of experimental data for calculating the oil film area on sea surface are generated in this experiment. No less than 70% (35 sets) of the data are selected to construct the predictive model and data training is performed. If a training result does not exceed an error range, the training is completed. After completing the training, half of remaining data (7 sets) is verified to verify accuracy of the predictive model, followed by testing on the other half of the remaining data (7 sets).

FIG. 7 is a performance diagram of mean squared error (MSE) metrics for a training process, from which it may be seen that the MSE metrics for the training, verification, and testing gradually decrease, and the MSE reached its minimum and optimal point in the 26th round. Table 1 below shows the input and output data of the predictive model.

TABLE 1

| | | | | | Output |
|---|---|---|---|---|---|
| | Input values | | | | value |
| | Leak- | Leakage | Leak- | Water | Oil fil |
| | age | aperture | age | flow | area on sea |
| | time | size | velocity | velocity | surface |
| No. | s | m | m/s | m/s | m² |
| 1 | 1.8 | 0.003 | 10 | 0.2 | 0.0235 |
| 2 | 2 | 0.003 | 10 | 0.2 | 0.0341 |
| 3 | 2.2 | 0.003 | 10 | 0.2 | 0.0790 |
| 4 | 2.4 | 0.003 | 10 | 0.2 | 0.1004 |
| 5 | 2.6 | 0.003 | 10 | 0.2 | 0.1153 |
| 6 | 2.8 | 0.003 | 10 | 0.2 | 0.1306 |
| 7 | 3 | 0.003 | 10 | 0.2 | 0.1465 |
| 8 | 1.8 | 0.0045 | 10 | 0.2 | 0.3571 |
| 9 | 2 | 0.0045 | 10 | 0.2 | 0.4243 |
| 10 | 2.2 | 0.0045 | 10 | 0.2 | 0.4966 |
| 11 | 2.4 | 0.0045 | 10 | 0.2 | 0.5652 |
| 12 | 2.6 | 0.0045 | 10 | 0.2 | 0.6320 |
| 13 | 2.8 | 0.0045 | 10 | 0.2 | 0.6703 |
| 14 | 3 | 0.0045 | 10 | 0.2 | 0.6991 |
| 15 | 1.8 | 0.006 | 10 | 0.2 | 0.6594 |
| 16 | 2 | 0.006 | 10 | 0.2 | 0.7392 |
| 17 | 2.2 | 0.006 | 10 | 0.2 | 0.8124 |
| 18 | 2.4 | 0.006 | 10 | 0.2 | 0.9068 |
| 19 | 2.6 | 0.006 | 10 | 0.2 | 0.9605 |
| 20 | 2.8 | 0.006 | 10 | 0.2 | 1.0604 |
| 21 | 3 | 0.006 | 10 | 0.2 | 1.1100 |
| 22 | 1.8 | 0.003 | 20 | 0.2 | 0.3807 |
| 23 | 2 | 0.003 | 20 | 0.2 | 0.4618 |
| 24 | 2.2 | 0.003 | 20 | 0.2 | 0.5538 |
| 25 | 2.4 | 0.003 | 20 | 0.2 | 0.6959 |
| 26 | 2.6 | 0.003 | 20 | 0.2 | 0.8468 |
| 27 | 2.8 | 0.003 | 20 | 0.2 | 0.8407 |
| 28 | 3 | 0.003 | 20 | 0.2 | 0.9133 |
| 29 | 1.8 | 0.003 | 30 | 0.2 | 0.6758 |
| 30 | 2 | 0.003 | 30 | 0.2 | 0.8124 |
| 31 | 2.2 | 0.003 | 30 | 0.2 | 0.9247 |
| 32 | 2.4 | 0.003 | 30 | 0.2 | 1.0321 |
| 33 | 2.6 | 0.003 | 30 | 0.2 | 1.1303 |
| 34 | 2.8 | 0.003 | 30 | 0.2 | 1.2154 |
| 35 | 3 | 0.003 | 30 | 0.2 | 1.2748 |
| 36 | 1.8 | 0.003 | 40 | 0.2 | 1.0549 |
| 37 | 2 | 0.003 | 40 | 0.2 | 1.1286 |
| 38 | 2.2 | 0.003 | 40 | 0.2 | 1.2765 |
| 39 | 2.4 | 0.003 | 40 | 0.2 | 1.3945 |
| 40 | 2.6 | 0.003 | 40 | 0.2 | 1.5381 |
| 41 | 2.8 | 0.003 | 40 | 0.2 | 1.6309 |
| 42 | 3 | 0.003 | 40 | 0.2 | 1.6751 |
| 43 | 1.8 | 0.003 | 10 | 0.1 | 0.1401 |
| 44 | 2 | 0.003 | 10 | 0.1 | 0.1759 |
| 45 | 2.2 | 0.003 | 10 | 0.1 | 0.2059 |
| 46 | 2.4 | 0.003 | 10 | 0.1 | 0.2307 |
| 47 | 2.6 | 0.003 | 10 | 0.1 | 0.2694 |
| 48 | 2.8 | 0.003 | 10 | 0.1 | 0.3062 |
| 49 | 3 | 0.003 | 10 | 0.1 | 0.3454 |

As may be seen in FIG. 8A, FIG. 8B, FIG. 8C, and FIG. 8D, the R correlation of the training, testing, and verification processes are 0.99307, 0.99951, and 0.99297, respectively, and the R correlation between the training, verification, and testing data with the fitting results all exceed 0.99. Dual verification proves that the predictive model has high reliability, accuracy, and practicality.

The error between the actual simulated oil film area on sea surface and the overall calculated value of the MATLAB software stays between −0.15 and +0.10, as shown in FIG. 9, and the overall R correlation is 0.99171, with the R correlation exceeding 0.99. Once again, it shows the reliability and accuracy of the predictive model constructed to predict oil spill accidents, which can quickly grasp the size of the oil film area on sea surface after the pipeline leakage, so that the accidents can be dealt with quickly and properly, significantly ensuring economic interests and reducing environmental pollution.

The above ideal embodiments based on the present disclosure serve as a revelation, and through the above-described content, those skilled in the relevant art may make diverse changes as well as modifications without deviating from the scope of the technical concepts of the present disclosure. The technical scope of the present disclosure is not limited to the contents of the present disclosure but must be determined according to the scope of the claims.

The basic concepts have been described above, and it is apparent to those skilled in the art that the foregoing detailed disclosure is intended as an example only and does not constitute a limitation of the present disclosure. While not expressly stated herein, various modifications, improvements, and amendments may be made to the present disclosure by those skilled in the art. Those types of modifications, improvements, and amendments are suggested in the present disclosure, so those types of modifications, improvements, and amendments remain within the spirit and scope of the exemplary embodiments of the present disclosure.

Some embodiments use numbers describing the count of components, attributes, and it is to be understood that such numbers used in the description of embodiments are modified in some examples by the modifiers “about”, “approximately”, or “substantially”. Unless otherwise noted, the terms “about,” “approximately,” or “substantially” indicate that a ±20% variation in the stated number is allowed. Correspondingly, in some embodiments, the numerical parameters used in the present disclosure and claims are approximations, which may change depending on the desired features of individual embodiments. In some embodiments, the numerical parameters should take into account the specified count of valid digits and use a general digit retention manner. While the numerical domains and parameters used to confirm the breadth of their ranges in some embodiments of the present disclosure are approximations, in specific embodiments such values are set to be as precise as possible within a feasible range.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A method for predicting an oil spill area on sea surface, implemented by a processor, comprising:
S1, obtaining a training dataset, including influencing factors affecting a leakage of a submarine oil pipeline;
S2, constructing an oil spill numerical model, and determining a predictive model by performing a predetermined processing on an initial predictive model based on simulation result data and the training dataset, the predictive model being a machine learning model;
S3, initializing the predictive model, determining a count of nodes of an input layer, an output layer, and a hidden layer, wherein an input of the input layer is the training dataset, the oil spill area on sea surface is an output of the output layer, and the count of nodes of the hidden layer is related to at least one of the count of nodes of the input layer and the count of nodes of the output layer; and
S4, obtaining input data and inputting the input data into the predictive model in S2 to obtain an oil spill area on sea surface to be measured.

2. The method of claim 1, wherein the predetermined processing includes training, testing, and verification, and
the method further comprises:
screening data satisfying a preset condition to train the initial predictive model among the simulation result data;
in response to a training result satisfying a training completion condition, determining that the training is completed;
testing the predictive model based on first remaining data to obtain accuracy of the predictive model;
verifying the predictive model based on second remaining data; and
obtaining that R correlation of the training, testing, and verification all exceeds a correlation threshold.

3. The method of claim 2, wherein an overall error value of the simulation result data and predetermined calculation software is kept between a predetermined range, and overall R correlation of the training, the testing, and the verification exceeds the correlation threshold.

4. The method of claim 1, wherein the training dataset includes historical leakage data; and
the method further comprises:
determining the predictive model by performing the predetermined processing on the initial predictive model based on the simulation result data, the training dataset, and an actual diffusion result, a ratio of a first sample count of the simulation result data to a second sample count of the actual diffusion result being determined based on a test feature.

5. The method of claim 4, wherein the historical leakage data is collected by means of a detection device or a movable standby detection device.

6. The method of claim 5, wherein the historical leakage data is calibrated data; and
a calibration includes:
obtaining first detection data of the detection device;
obtaining second detection data of the standby detection device; and
obtaining the calibrated data by performing a comprehensive processing on the first detection data and the second detection data.

7. The method of claim 6, wherein the comprehensive processing includes a weighting processing, and a first weight of the first detection data and a second weight of the second detection data are determined based on detection device data.

8. The method of claim 6, wherein a count of standby detection devices is determined based on submarine environment in which a historical leakage pipeline is located.

9. The method of claim 4, wherein the predictive model includes a feature extraction layer and a first prediction layer; and
the method further comprises:
determining a feature vector through the feature extraction layer based on a leakage aperture size, a leakage velocity, and a water flow velocity; and
determining an oil film area on sea surface at at least one future time point through the first prediction layer based on the feature vector and a leakage time series, the at least one future time point corresponding to the leakage time series.

10. The method of claim 9, wherein the predictive model further includes a second prediction layer; and
the method further comprises:
determining an oil film area distribution at the at least one future time point through the second prediction layer based on the feature vector, the leakage time series, a weather condition in a future time period and a location of a leakage pipeline.

11. The method of claim 4, wherein the predictive model further includes a third prediction layer; and
the method further comprises:
determining an appearance time of an oil film through the third prediction layer based on a leakage aperture size, a leakage velocity, a water flow velocity and a weather condition in a future time period.

12. A system for predicting an oil spill area on sea surface, comprising an obtaining module, a first determination module, a second determination module, and a prediction module;
the obtaining module is configured to obtain a training dataset, including influencing factors affecting a leakage of a submarine oil pipeline;
the first determination module is configured to construct an oil spill numerical model, and determine a predictive model by performing a predetermined processing on an initial predictive model based on simulation result data and the training dataset, the predictive model being a machine learning model;
the second determination module is configured to initialize the predictive model, determine a count of nodes of an input layer, an output layer, and a hidden layer, wherein an input of the input layer is the training dataset, the oil spill area on sea surface is an output of the output layer, and the count of nodes of the hidden layer is related to at least one of the count of nodes of the input layer and the count of nodes of the output layer; and
the prediction module is configured to obtain input data and inputting the input data into the predictive model to obtain an oil spill area on sea surface to be measured.

13. The system of claim 12, wherein the predetermined processing includes training, testing, and verification, the first determination module is further configured to:
screen data satisfying a preset condition to train the initial predictive model among the simulation result data;
in response to a training result satisfying a training completion condition, determine that the training is completed;
test the predictive model based on first remaining data to obtain accuracy of the predictive model;
verify the predictive model based on second remaining data; and
obtain that R correlation of training, testing, and verification all exceeds a correlation threshold.

14. The system of claim 12, wherein the training dataset includes historical leakage data; and the first determination module is further configured to:
determine the predictive model by performing the predetermined processing on the initial predictive model based on the simulation result data, the training dataset, and an actual diffusion result, a ratio of a first sample count of the simulation result data to a second sample count of the actual diffusion result being determined based on a test feature.

15. The system of claim 14, wherein the historical leakage data is collected by means of a detection device or a movable standby detection device.

16. The system of claim 15, wherein the historical leakage data is calibrated data;
and the first determination module is further configured to:
obtain first detection data of the detection device;
obtaining second detection data of the standby detection device; and
obtain the calibrated data by performing a comprehensive processing on the first detection data and the second detection data.

17. The system of claim 14, wherein the predictive model includes a feature extraction layer and a first prediction layer; and the prediction module is further configured to:
determine a feature vector through the feature extraction layer based on a leakage aperture size, a leakage velocity, and a water flow velocity; and
determine an oil film area on sea surface at at least one future time point through the first prediction layer based on the feature vector and a leakage time series, the at least one future time point corresponding to the leakage time series.

18. The system of claim 17, wherein the predictive model further includes a second prediction layer; and the prediction module is further configured to:
determine an oil film area distribution at the at least one future time point through the second prediction layer based on the feature vector, the leakage time series, a weather condition in a future time period and a location of a leakage pipeline.

19. The system of claim 14, wherein the predictive model further includes a third prediction layer; and the prediction module is further configured to:
determine an appearance time of an oil film through the third prediction layer based on a leakage aperture size, a leakage velocity, a water flow velocity and a weather condition in a future time period.

20. A non-transitory computer-readable storage medium storing a computer instruction and when executed by a processor, the computer instruction implements the method for predicting an oil spill area on sea surface of claim 1.
